(19) United States
(12) Patent Application Publication
(10) Pub. No.: US 2023/0265870 A1
(43) Pub. Date: Aug. 24, 2023

(54) WORK MACHINE AND METHOD FOR CALIBRATING AN ELECTROHYDRAULIC PUMP IN AN OPEN CENTER HYDRAULIC SYSTEM

(71) Applicant: Deere & Company, Moline, IL (US)

(72) Inventors: Justin Sticksel, Galena, IL (US); Aaron R. Kenkel, East Dubuque, IL (US); Jeff Dobchuk, Saskatchewan (CA); Bryan J. Rausch, Durango, IA (US); Madeline T. Oglesby, Asbury, IA (US)

(21) Appl. No.: 17/651,920

(22) Filed: Feb. 22, 2022

(51) Int. Cl. F15B 19/00; F15B 15/18

(52) U.S. Cl. CPC F15B 19/002; F15B 15/18

(57) ABSTRACT

A work machine and method for a work machine with an open center hydraulic system for controlling actuation of an implement includes an implement control valve, an electro-hydraulically controlled pump, a hydraulic circuit coupled to the implement actuator, and a pressure transducer positioned for measuring a pressure in the hydraulic circuit between the pump and the implement control valve. A calibration system for calibrating the pump includes a controller having a non-transitory computer readable medium having a program instruction for causing a processor to calibrate a first threshold for the pump in a pump-flow curve wherein the first threshold including a minimum current command to actuate the pump; determine a hysteresis band in the pump-flow curve; and calibrate a second threshold for the pump in the pump-flow curve wherein the second threshold including a maximum current command to actuate the pump below a relief setpoint.

### CROSS-REFERENCE TO RELATED APPLICATIONS

[symbol]

### FIELD OF THE DISCLOSURE

The present disclosure relates to a work machine and a method for calibrating an electrohydraulic pump in an open center hydraulic system.

### BACKGROUND

In industrial or construction work machines, a system of hydraulic pumps, valves, and actuators are often used to produce motion for an implement. Various technologies exist to manage the control of these hydraulic devices. Systems can be developed that blend elements of each available technology. Some systems rely purely on hydromechanical means of controlling pumps, valves, and actuators (also commonly referred to as manual or pilot operated controls). Other systems, however, incorporate electronic devices for control (commonly known as electro-hydraulic controls). Electro-hydraulic devices can be utilized to control hydraulic pumps and valves. These devices can take on various design forms. One embodiment for an electro-hydraulic control device is the use of an electronic solenoid to induce electro-magnetic forces either directly or indirectly on a valve spool by subjecting the solenoid to a given electrical current. The actuation of the valve spool by the solenoid is used to induce a given hydraulic pressure, which may then be used to pilot a main stage valve spool or pump. This provides the ability to electronically control the flow or pressure in a hydraulic circuit, which is ideal for implementation in complex control systems that utilize microcontrollers. Depending on the application of electro-hydraulic devices in a given system, a method for calibrating components is often necessary to optimize system performance. A nominal input/output relationship for a device can be determined based on the component design. However, manufacturing tolerances may deviate the system from theoretical nominal performances from one component to the next. Calibration routines are often developed to account for such variances. Therein lies an opportunity to develop a calibration routine optimized to account for variances in pump performance in an open center hydraulic system.

### SUMMARY

This summary is provided to introduce a selection of concepts that are further described below in the detailed description and accompanying drawings. This summary is not intended to identify key or essential features of the appended claims, nor is it intended to be used as an aid in determining the scope of the appended claims.

The present disclosure relates to an apparatus with a calibration system, and method of calibrating the pump in an open center hydraulic system on a work machine. The work machine comprises an open center hydraulic system, and a calibration system. The open center hydraulic system controls actuation of the implement. The open center hydraulic system includes an implement control valve configured to control a flow of the fluid to and from an implement actuator in response to a first control signal. The hydraulic system also includes an electro-hydraulically controlled pump for controlling the outlet flow of the fluid through a hydraulic circuit in response to a second control signal. This hydraulic circuit is coupled to the implement actuator. A pressure transducer is positioned for measuring a pressure in the hydraulic circuit between the pump and the implement control valve. The calibration system calibrates the pump for controlling the flow of fluid through the open center hydraulic system. The calibration system includes a controller having a non-transitory computer readable medium with a program instruction to do the following steps. The program instruction includes calibrating a first threshold and second threshold for the pump in a pump-flow curve and determining a hysteresis band in the pump-flow curve. The first threshold includes a minimum current command to actuate the pump. The second threshold includes a maximum current command to actuate the pump below a relief setpoint.

Calibrating the first threshold for the pump in the pump-flow curve may comprise of setting the pump at a constant flowrate, identifying an implement control valve command for a restriction setting, recording the pump pressure, initializing a pump calibration step point, ramping the first control signal until the pressure changes to a predetermined value, correlating the pressure change to the change in the flow of fluid to the implement actuator to identify a given point on the pump-flow curve, outputting an adjustment signal for adjusting the first threshold, and iteratively repeating the outputting of the adjustment signal based on a repeated ramping of the first control signal until the adjustment signal falls within a predetermined range.

Calibrating the second threshold for the pump in the pump-flow curve may comprise of setting the pump at a constant flowrate, identifying an implement control valve command for a restriction setting, ramping the second control signal beyond a nominal full stroke actuation of the implement, recording the pump pressure, ramping the first control signal, outputting an adjustment signal for adjusting the second threshold, and iteratively repeating the outputting of the adjustment signal based on a repeated ramping of the second control signal until the adjustment signal falls within a predetermined range.

Determining the hysteresis band in the pump-flow curve may comprise of ramping the second control signal until the pressure drops, determining a pressure drop target by correlating the pressure to a change in the flow of fluid to the implement actuator, outputting an adjustment signal for adjusting the pressure drop target, and iteratively repeating the output of the adjustment signal based on a repeated ramping of the second control signal until the adjustment signal falls within a predetermined range.

Prior to the calibration, the fluid will be within an operating temperature range prior to proceeding with the calibrating process.

Prior to the calibration, the engine speed will be within an operating speed range prior to proceeding with the calibrating process.

Other features and aspects of the disclosure will become apparent by consideration of the following detailed description and accompanying drawings.

### BRIEF DESCRIPTION OF THE DRAWINGS

FIG. 1 depicts an embodiment of an open center hydraulic valve system diagram;

FIG. 2 depicts an embodiment of a pump-flow curve;

FIG. 3 depicts a flow diagram for calibrating the minimum current command to actuate the pump;

FIG. 4 depicts a flow diagram for calibrating the maximum current command to actuate the pump below a relief setpoint;

FIG. 5 depicts a flow diagram for calibrating the hysteresis; and

FIG. 6 depicts a flow diagram for calibrating the second threshold for the pump in the pump-flow curve.

Before any embodiments are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting.

### DETAILED DESCRIPTION

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “one or more of A, B, and C” or “at least one of A, B, and C” indicates the possibilities of only A, only B, only C, or any combination of two or more of A, B, and C (e.g., A and B; B and C; A and C; or A, B, and C).

As used herein, the term “controller” is a computing device including a processor and a memory. The “controller” may be a single device or alternatively multiple devices. The controller may further refer to any hardware, software, firmware, electronic control component, processing logic, processing device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

The term “processor” is described and shown as a single processor. However, two or more processors can be used according to particular needs, desires, or particular implementations of the controller and the described functionality. The processor may be a component of the controller, a sub-controller for actuation, or alternatively a part of another device. Generally, the processor can execute program instructions and can manipulate data to perform the operations of the controller, including operations using algorithms, methods, functions, processes, flows, and procedures as described in the present disclosure.

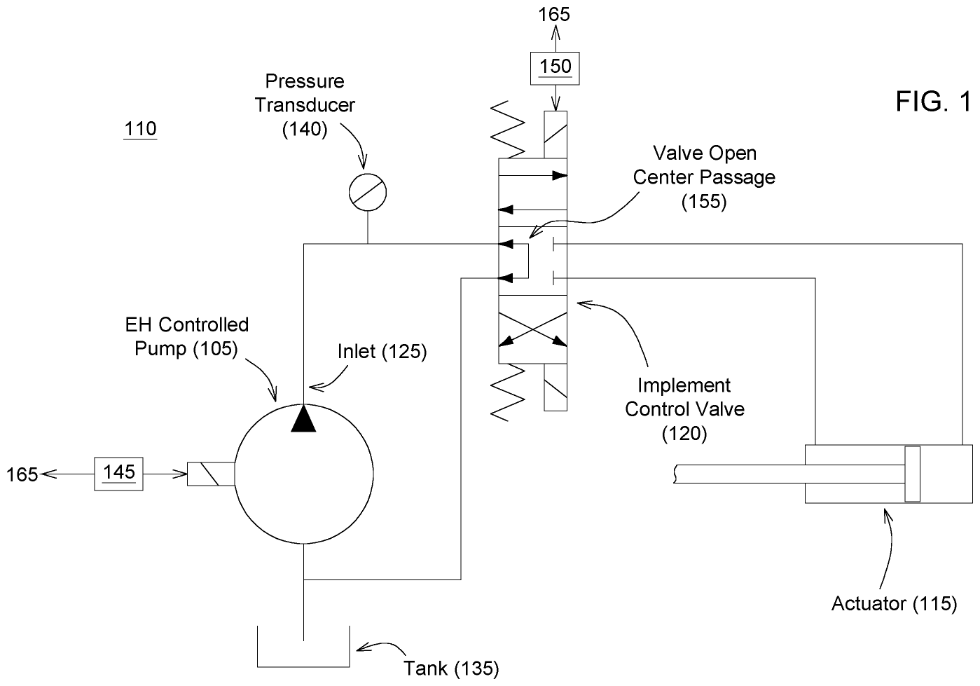

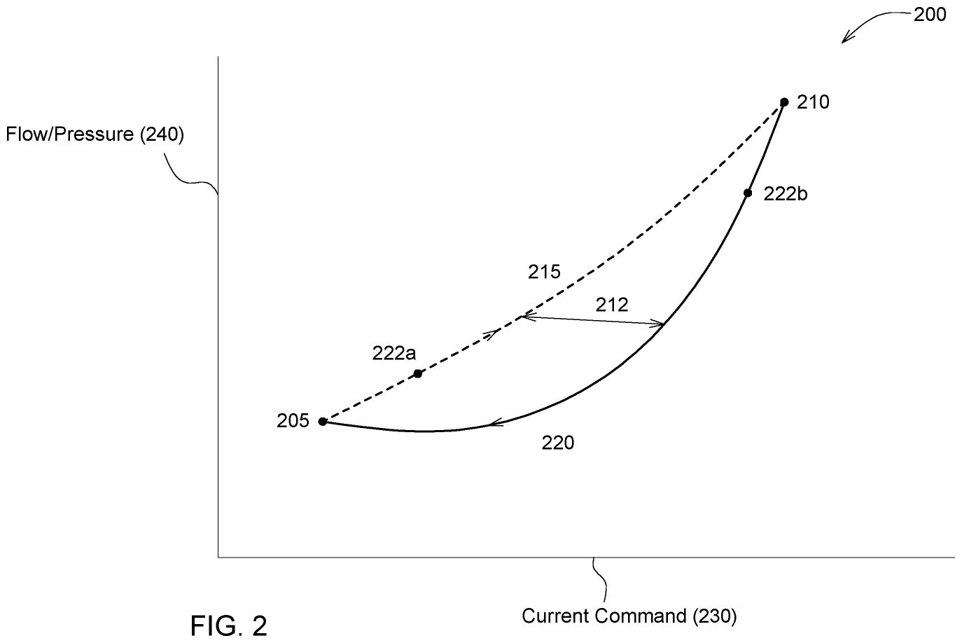

With references to FIGS. 1 and 2, the present disclosure is directed towards a work machine and method for calibrating an electro-hydraulic pump 105 in an open center hydraulic system 110 wherein the system is for controlling actuation of an implement 115 coupled to the work machine. In the embodiment shown in FIG. 1, the system 110 includes an electro-hydraulically controlled main implement control valve 120 coupled to an independent electro-hydraulically controlled pump 105. The valve 120 in this system is an “open center” type, meaning that when the valve 120 is neutralized a passage is opened to allow flow of hydraulic fluid to pass freely between the inlet 125 and tank ports. In this system, the pressure in the work circuit between the pump 105 and the valve 120 is measured by a pressure transducer 140. The pump position is controlled by a hydraulic pressure piloted from an electro-hydraulic valve. The pressure that pilots the pump 105 is proportional to the electrical current driven to the control solenoid, hereinafter also referred to as the second control signal 150 or current command. A “minimum” current command starts moving the pump, and a “maximum” current command 210 achieves full actuation of the pump 105. A “hysteresis” band 212 exists that dictates the difference between the “upslope” flow curve 215 and the “downslope” flow curve 220. The work machine with the disclosed calibration system and method includes identifying two calibration points (222a, 222b), as well as a hysteresis band 212.

In the open center hydraulic valve 120, the center passage 155 is typically closed off at some rate as one of the work circuit passages 160 is opened up. The timing of this transition can vary from valve to valve, but typically the center passage 155 is not completely closed off until the work circuit passages 160 are at least partially opened. This ensures that there is always a path for flow, and the ratio of the orifices formed in the center passage 155 and the work circuit passage 160 dictate the flow split. There is, however, a point in the valve spool travel range wherein the center passage 155 starts to restrict (often substantially) before the work circuit passage 160 opens up. This “restriction setting” 307 can be used to create a known restrictive path for pump flow, which provides a method for calibrating the “minimum” calibration point 222a for the hydraulic pump 105. Pump calibration establishes an area opening downstream of the pump 105. If that area remains consistent for the duration of the calibration, a precise change in flow is identifiable as a function of a change in pressure.

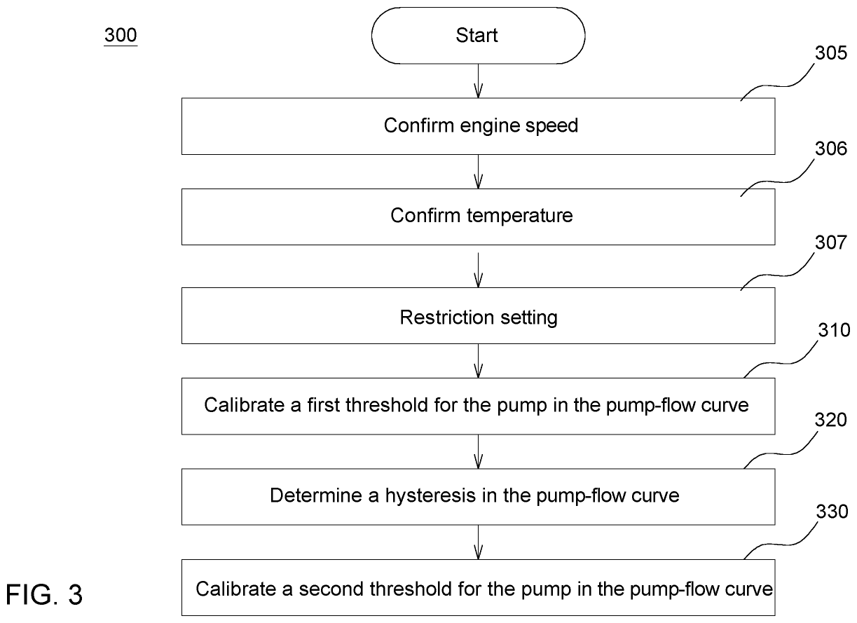

Now referencing FIG. 3 with continued reference to FIG. 2, several pre-conditions may be required to optimize accuracy and/or precision in calibration. As shown in step 305, one condition may include confirming the engine speed is within an operating speed range prior to calibrating. Engine speed must be sufficiently set to achieve consistent pump flows relative to control commands. This may include low idle or a wide-open throttle based on the design of the program instructions. In step 306, another condition may include confirming if the fluid in the hydraulic circuit is within an operating temperature range prior to calibrating. Generally, fluid outside the normal operating temperature range may differ in viscosity and impact the accuracy of calibration. For example, performing the calibration routine if the fluid temperature is below the normal operating temperature range may yield “minimum current” command, a “maximum current” command, and a hysteresis different from normal operation. In this scenario, the program instructions will require a delay in commencing calibration until a correct temperature of the fluid is achieved. Additionally, the program instructions will not necessarily identify the exact “minimum current” command 205, the “maximum current” command 210, or the magnitude of the hysteresis 212. However, the program instructions identify points (222a, 222b) along the pump-flow curve 200 from which a true value may be extrapolated. Restriction settings may also depend upon on the hydraulic fluid temperature and engine speed. If either of the variables fall outside the defined boundaries, the method halts prior to continuing. The calibration method 300 for the pump 105 includes the pump controlling the flow of fluid through the open center hydraulic system 110. The pump position is controlled by a hydraulic pressure piloted from an electrohydraulic valve. The pressure that pilots the pump is proportional to the electrical current driven to the control solenoid. The open center hydraulic system includes a controller 165 having a non-transitory computer readable medium with a program instruction configured to cause a processor on the controller to do the following method 300. In step 310, the method 300 includes calibrating a first threshold 205 for the pump in the pump-flow curve 200, wherein the first threshold 205 includes the minimum current command to actuate the pump 105. In step 320, the method 300 then determines a hysteresis band 212 in the pump-flow curve 200. Finally, in step 330, the method 300 then calibrates a second threshold 210 for the pump 105 in the pump-flow curve 200, wherein the second threshold 210 includes a maximum current command 210 to actuate the pump 105 below the relief setpoint (not shown).

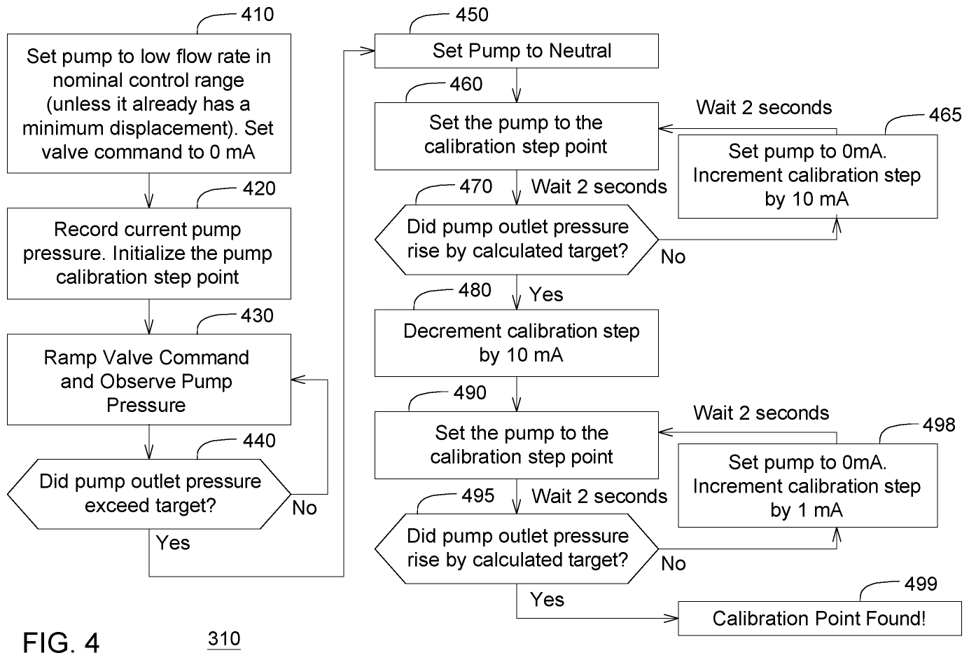

The flow diagram for calibrating the “minimum current” command 222a to actuate the pump is shown in FIG. 4. The program instructions for calibrating the first threshold 205 for the pump in the pump-flow curve 200 comprises the following steps. In a first step 410, the method 310 includes setting the pump 105 at a constant flowrate. In the embodiment shown, the pump 105 is set to a low flow rate in a nominal control range, and the valve command is set to neutral. For example, in one embodiment neutral is set at 0 mA. Next, in step 420, the program instructions identify the implement control valve command for the restriction setting, records the current pump pressure, and initializes a pump calibration step point. Once this restrictive path for the pump flow is set, the pressure measurement at the pump outlet can be used to derive a relation correlating a pressure change to a flow change. Steps 430 and 440, the program instructions begin calibration by ramping the first control signal 145 until the pressure changes a predetermined value, and correlating the pressure change to a change in the flow of fluid to the implement actuator to identify a given point on the pump-flow curve 200. Once this given point is identified and the flow/pressure relationship is derived, the pump may be neutralized as shown in step 450, and stepping on and off incrementally until a pressure rise at the outlet is identified. Finally, the program instructions output an adjustment signal 315 for adjusting the first threshold 205, and iteratively repeats the outputting of the adjustment signal 315 based on a repeated ramping of the first control signal 145 until the adjustment signal 315 falls within a predetermined range. For example, the program instructions may ramp the valve command up and down in order to narrow in on a target range (i.e. the “closed loop” method). This may be done at least twice. In a first iteration (step 460 through step 480) , this may be done using “coarse” increments, and in a second iteration (step 490 through step 495), this may be done using “fine” increments. Pump rotation speed can dictate pump outlet flow. If the engine speed is pulled up or down from the speed targeted for the calibration, the adjustment signal 315 may be compensated to scale the expected flowrate.

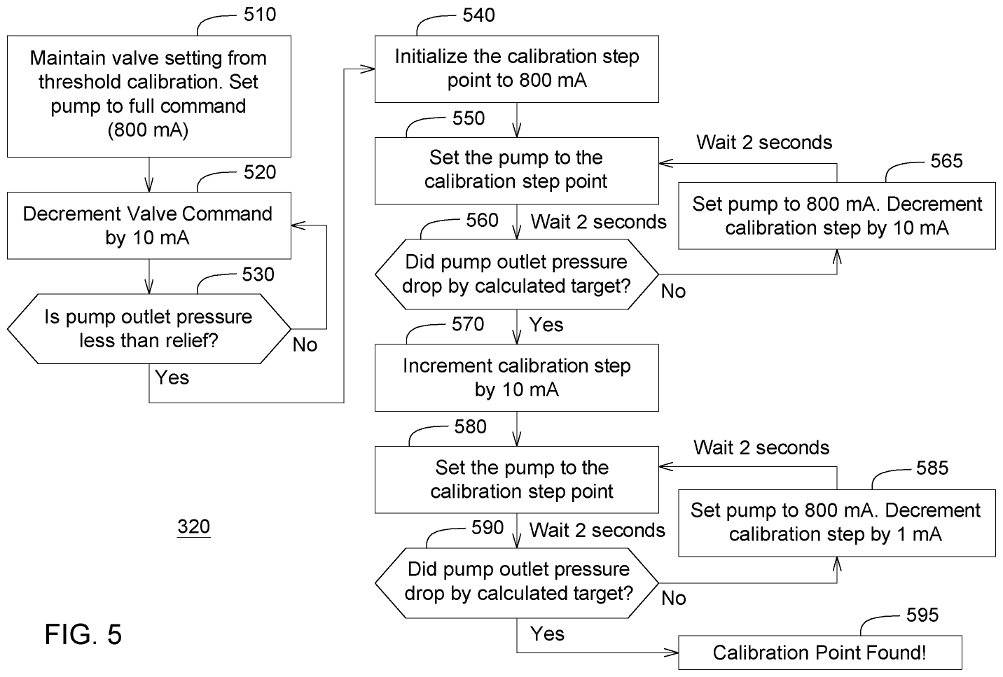

Now turning to FIG. 5, the program instructions for determining the hysteresis band 212 in the pump-flow curve 200 baselines a pressure drop across the main implement control valve 120 at full fluid flow and subsequently steps down the pump command until a pressure drop across the valve 120 at full flow is observed. The reduction in pressure is a proxy for a reduction in flow. The observed pressure drop indicates the flow has begun to reduce and that is the hysteresis band 212 for the pump. The program instructions comprise of ramping the second control signal 150 until the pressure drops; determining a pressure drop target by correlating the pressure to a change in the flow of fluid to the implement actuator 115, outputting an adjustment signal 315 for adjusting the pressure drop target, and iteratively repeating the outputting of the adjustment signal based on a repeated ramping of the second control signal 150 until the adjustment signal falls within a predetermined range.

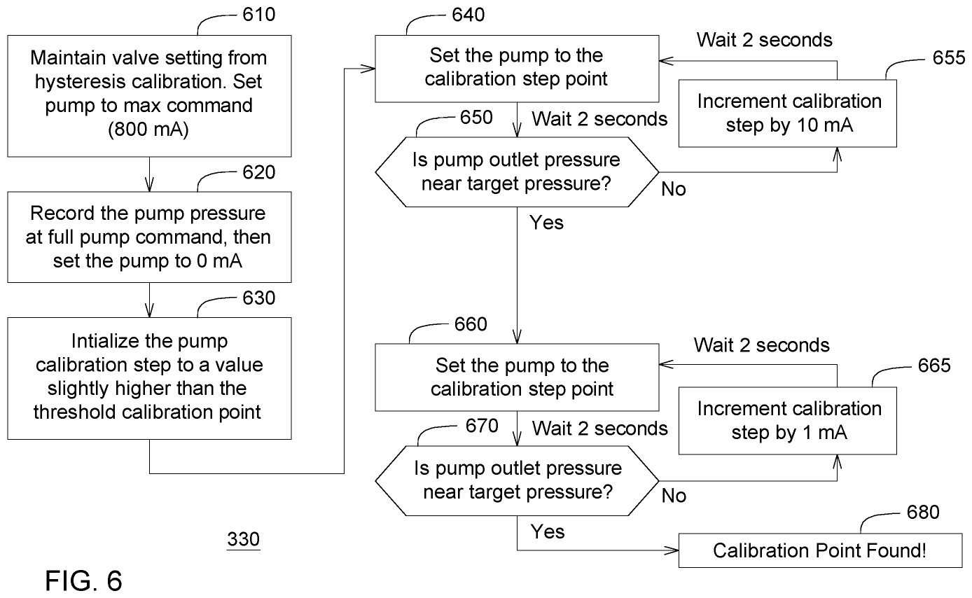

Once the hysteresis band 212 is determined, a final calibration identifies the second threshold 210 (or true max flow for the pump). FIG. 6 details a flowchart of the program instruction for the method of calibrating the second threshold 210 for the pump in the pump-flow curve 200 comprises setting the pump at a constant flowrate and identifying the implement control valve command for a restriction setting in step 610. The program instructions include ramping the first control signal 145 beyond a nominal full stroke actuation of the implement as shown, thereby generating a substantial pressure drop across the implement valve 120. The pump pressure at full pump command is recorded and set to neutral (0 mA in the present embodiment) in step 620. The pressure observed at the pump outlet is the calibration “target” pressure. The A calibration of the second threshold (i.e. the pump-flow curve 200) then starts by stepping the pump 105 down from full command until a pressure drop is observed at the pump outlet, indicating that flow (and thus pump displacement) has reduced. Similar to the pump hysteresis routine, this pressure drop target can be calculated as a function of the flow/pressure relationship established when the pump 105 is set to full command. Also, similar to the first part of the calibration routine, this can be executed twice, once using “coarse” decrements and once using “fine” decrements. the pressure at the pump outlet is within some range of the determined target pressure during the course “ramp up”, then the “fine” calibration mode takes over. During the “fine calibration”, a tighter window to the target pressure is used to determine if the calibration point is found. To shorten this routine, the initial “calibration step” for the pump can be set to a value in the known metering range for the pump (a value slightly above the threshold value found previously).

One or more of the steps or operations in any of the methods, processes, or systems discussed herein may be omitted, repeated, or re-ordered and are within the scope of the present disclosure.

While the above describes example embodiments of the present disclosure, these descriptions should not be viewed in a restrictive or limiting sense. Rather, there are several variations and modifications which may be made without departing from the scope of the appended claims.

What is claimed is:

1. A work machine with an implement coupled to the work machine, the work machine comprising:
an open center hydraulic system for controlling actuation of the implement, the open center hydraulic system including
an implement control valve configured to control a flow of a fluid to and from an implement actuator in response to a first control signal,
an electro-hydraulically controlled pump for controlling the outlet flow of the fluid through a hydraulic circuit in response to a second control signal, the hydraulic circuit coupled to the implement actuator, and
a pressure transducer positioned for measuring a pressure in the hydraulic circuit between the pump and the implement control valve; and
a calibration system for calibrating the pump for controlling the flow of the fluid through the open center hydraulic system, the calibration system including a controller having a non-transitory computer readable medium having a program instruction for causing a processor to
calibrate a first threshold for the pump in a pump-flow curve, the first threshold including a minimum current command to actuate the pump;
determine a hysteresis band in the pump-flow curve; and
calibrate a second threshold for the pump in the pump-flow curve, the second threshold including a maximum current command to actuate the pump below a relief setpoint.

2. The work machine of claim 1, wherein the program instructions for calibrating the first threshold for the pump in the pump-flow curve comprises:
setting the pump at a constant flowrate;
identifying an implement control valve command for a restriction setting;
recording the pump pressure;
initializing a pump calibration step point;
ramping the first control signal until the pressure changes to a predetermined value;
correlating a pressure change to a change in the flow of fluid to the implement actuator to identify a given point on the pump-flow curve;
outputting an adjustment signal for adjusting the first threshold; and
iteratively repeating the outputting of the adjustment signal based on a repeated ramping of the first control signal until the adjustment signal falls within a predetermined range.

3. The work machine of claim 1, wherein the program instructions for calibrating the second threshold for the pump in the pump-flow curve comprises:
setting the pump at a constant flowrate;
identifying an implement control valve command for a restriction setting;
ramping the second control signal beyond a nominal full stroke actuation of the implement;
recording the pump pressure;
ramping the first control;
outputting an adjustment signal for adjusting the second threshold; and
iteratively repeating the outputting of the adjustment signal based on a repeated ramping of the second control signal until the adjustment signal falls within a predetermined range.

4. The work machine of claim 1, wherein the program instructions for determining the hysteresis band in the pump-flow curve comprises:
ramping the second control signal until the pressure drops;
determining a pressure drop target by correlating the pressure to a change in the flow of fluid to the implement actuator;
outputting an adjustment signal for adjusting the pressure drop target; and
iteratively repeating the outputting of the adjustment signal based on a repeated ramping of the second control signal until the adjustment signal falls within a predetermined range.

5. The work machine of claim 1, wherein the fluid is within an operating temperature range prior to calibrating.

6. The work machine of claim 1, wherein an engine speed is within an operating speed range prior to calibrating.

7. A computer readable medium for a work machine with an implement mechanically coupled to the work machine wherein an open center hydraulic system controls actuation of the implement, the open center hydraulic system including an implement control valve configured to control a flow of a fluid to and from an implement actuator in response to a first control signal and a pump for controlling the outlet flow of the fluid through a hydraulic circuit in response to a second control signal, the computer readable medium comprising a program instruction for causing a processor of a controller to:
calibrate a first threshold in a pump-flow curve for a pump in the open center hydraulic system, the first threshold including a minimum current command to actuate the pump;
determine a hysteresis band in the pump-flow curve; and
calibrate a second threshold in the pump-flow curve for the pump, the second threshold including a maximum current command to actuate the pump below a relief setpoint.

8. The computer readable medium of claim 7, wherein the program instructions for calibrating the first threshold for the pump in the pump-flow curve comprises:
setting the pump at a constant flowrate;
identifying an implement control valve command for a restriction setting;
recording a current pump pressure;
initializing a pump calibration step point;
ramping the first control signal until the pressure changes a predetermined value;
correlating a pressure change to a change in the flow of fluid to the implement actuator to identify a given point on the pump-flow curve;
outputting an adjustment signal for adjusting the first threshold; and
iteratively repeating the outputting of the adjustment signal based on a repeated ramping of the first control signal until the adjustment signal falls within a predetermined range.

9. The computer readable medium of claim 7, wherein the program instructions for calibrating the second threshold for the pump in the pump-flow curve comprises:
setting the pump at a constant flowrate;
identifying an implement control valve command for a restriction stetting;
ramping the second control signal beyond a nominal full stroke actuation of the implement;
recording the pump pressure;
ramping the first control signal;
outputting an adjustment signal for adjusting the second threshold; and
iteratively repeating the outputting of the adjustment signal based on a repeated ramping of the second control signal until the adjustment signal falls within a predetermined range.

10. The computer readable medium of claim 7, wherein the program instructions for determining a hysteresis band in the pump-flow curve comprises:
ramping the second control signal until the pressure drops;
determining a pressure drop target by correlating the pressure to a change in the flow of fluid to the implement actuator;
outputting an adjustment signal for adjusting the pressure drop target; and iteratively repeating the outputting of the adjustment signal based on a repeated ramping of the second control signal until the adjustment signal falls within a predetermined range.

11. The computer readable medium of claim 7, wherein the program instructions further comprise:
confirming the fluid is within an operating temperature range prior to calibrating.

12. The computer readable medium of claim 7, wherein the program instructions further comprise:
confirming an engine speed is within an operating speed range prior to calibrating.

13. A method of calibrating a pump in an open center hydraulic system for controlling actuation of an implement coupled to a work machine, the open center hydraulic system including an implement control valve configured to control a flow of a fluid to and from an implement actuator in response to a first control signal and a pump for controlling the outlet flow of the fluid through a hydraulic circuit in response to a second control signal, the method comprising:
calibrating a first threshold in a pump-flow curve for a pump in the open center hydraulic system, the first threshold including a minimum current command to actuate the pump;
determining a hysteresis band in the pump-flow curve; and
calibrating a second threshold in the pump-flow curve for the pump, the second threshold including a maximum current command to actuate the pump below a relief setpoint.

14. The method of claim 13, wherein calibrating the first threshold for the pump in a pump-flow curve comprises:
setting the pump at a constant flowrate;
identifying an implement control valve command for a restriction setting;
recording a current pump pressure;
initializing a pump calibration step point;
ramping the first control signal until the pressure changes a predetermined value;
correlating a pressure change to a change in the flow of fluid to the implement actuator to identify a given point on the pump-flow curve;
outputting an adjustment signal for adjusting the first threshold;
iteratively repeating the outputting of the adjustment signal based on a repeated ramping of the first control signal until the adjustment signal falls within a predetermined range.

15. The method of claim 13, wherein calibrating the second threshold for the pump in a pump-flow curve comprises:
setting the pump at a constant flowrate;
identifying an implement control valve command for a restriction stetting;
ramping the second control signal beyond a nominal full stroke actuation of the implement;
recording the pump pressure;
ramping the first control signal;
outputting an adjustment signal for adjusting the second threshold; and
iteratively repeating the outputting of the adjustment signal based on a repeated ramping of the second control signal until the adjustment signal falls within a predetermined range.

16. The method of claim 13, wherein determining a hysteresis band in the pump-flow curve comprises:
ramping the second control signal until the pressure drops;
determining a pressure drop target by correlating the pressure to a change in the flow of fluid to the implement actuator;
outputting an adjustment signal for adjusting the pressure drop target; and iteratively repeating the outputting of the adjustment signal based on a repeated ramping of the second control signal until the adjustment signal falls within a predetermined range.

17. The method of claim 13, wherein the method further comprises:
confirming the fluid is within an operating temperature range prior to calibrating.

18. The method of 13, wherein the method further comprises:
confirming an engine speed is within an operating speed range prior to calibrating.
